(19) United States
(12) Patent Application Publication
(10) Pub. No.: US 2012/0198021 A1
(43) Pub. Date: Aug. 2, 2012

(54) SYSTEM AND METHOD FOR SHARING MARKER IN AUGMENTED REALITY

(75) Inventor: Kye Hyuk AHN, Bucheon-si (KR)

(73) Assignee: PANTECH CO., LTD., Seoul (KR)

(21) Appl. No.: 13/312,885

(22) Filed: Dec. 6, 2011

(30) Foreign Application Priority Data
Jan. 27, 2011 (KR) 10-2011-0008073

(51) Int. Cl. G06F 15/16

(52) U.S. Cl. 709/217

(57) ABSTRACT

In an augmented reality (AR) system and method for dividing and sharing a marker, the AR system includes a host device and a client device. A method for providing an augmented reality (AR) includes detecting a marker including a first area and a second area in a preview image; transceiving information of the marker and area information of the marker; identifying the first area and the second area of the marker using the area information of the marker; extracting a first AR object corresponding to the first area or a second AR object corresponding to the second area; and displaying the first AR object or the second AR object.

### CROSS-REFERENCE TO RELATED APPLICATION

This application claims priority from and the benefit under 35 U.S.C. §119(a) of Korean Patent Application No. 10-2011-0008073, filed on Jan. 27, 2011, which is incorporated by reference for all purposes as if fully set forth herein.

### BACKGROUND

1. Field

The present disclosure relates to a system and method for providing augmented reality, and more particularly, to a system and method for sharing a marker and an augmented reality object in an augmented reality environment.

2. Discussion of the Background

An augmented reality (AR) is an evolved form of a virtual reality. Through the augmented reality, a real world-image, and a virtual-world image having additional information may be combined, and the combined image may be displayed on a display device as a single image. The AR technology is based on a concept for enhancing one's perception of the real world with a virtual world. A virtual environment created by a computer graphic technique may be used in the AR technology. However, the real world takes a significant part in the AR technology. The computer graphic technique may provide additional information to the real-world image. In the AR technology, it may be difficult to distinguish between the real world and the virtual world due to the computer graphic technique overlapping a three-dimensional virtual image on a real world image, which the user views in the real world. In one type of the AR technology, a computer may recognize a marker and display a three-dimensional graphic model, and a three-dimensional object, mapped to the marker on a display device.

### SUMMARY

Exemplary embodiments of the present invention may provide a system and method for sharing a marker in an augmented reality, more particularly, to a system and method for dividing a marker into multiple areas and providing an access authorization with respect to each of the multiple areas to share an AR object with a user having the access authorization.

Additional features of the invention will be set forth in the description which follows, and in part will be apparent from the description, or may be learned by practice of the invention.

Exemplary embodiments of the present invention provide a first client device of an augmented reality (AR) system including a detection unit to identify a marker including a first area and a second area; a sharing unit to transceive information of the marker and area information of the marker; an area tracking unit to identify the first area and the second area using the area information of the marker; an engine management unit to extract a first AR object corresponding to the first area and a second AR object corresponding to the second area; and an engine unit to display the first AR object and the second AR object.

Exemplary embodiments of the present invention provide a host device of an augmented reality (AR) system including an object storage unit to store a first AR object corresponding to a first area of a marker and a second AR object corresponding to a second area of the marker; and a sharing unit to transmit information of the marker and area information of the marker to one or more client devices participating in an AR session, to transmit information of the first AR object corresponding to the first area of the marker to one or more client devices if the one or more client devices have an access authorization to the first area of the marker, and to transmit information of the second AR object corresponding to the second area of the marker to one or more client devices if the one or more client devices have an access authorization to the second area of the marker.

Exemplary embodiments of the present invention provide a method for providing an augmented reality (AR) including detecting a marker including a first area and a second area in a preview image; transceiving information of the marker and area information of the marker; identifying the first area and the second area of the marker using the area information of the marker; extracting a first AR object corresponding to the first area or a second AR object corresponding to the second area; and displaying the first AR object or the second AR object.

Exemplary embodiments of the present invention provide a method for providing an augmented reality (AR) including establishing an AR session using a marker having a first area and a second area; determining one or more client devices as participants of the AR session; sharing information of the marker and area information of the marker with the one or more client devices participating in the AR session; and sharing a first AR object corresponding to the first area of the marker with a first client device authorized to the first area, and sharing a second AR object corresponding to the second area of the marker with a second client device authorized to the second area.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an augmented reality (AR) system according to an exemplary embodiment of the present invention.

FIG. 2 is a block diagram illustrating a host device in an AR system according to an exemplary embodiment of the present invention.

FIG. 3 is a block diagram illustrating a client device in an AR system according to an exemplary embodiment of the present invention.

FIG. 4 is a diagram illustrating a marker divided into multiple areas according to an exemplary embodiment of the present invention.

FIG. 5 is a flowchart illustrating a method for generating an AR session in a client device of an AR system according to an exemplary embodiment of the present invention.

FIG. 6 is a flowchart illustrating a method for participating in an AR session in a client device of an AR system according to an exemplary embodiment of the present invention.

FIG. 7 is a flowchart illustrating a method for changing area information of a marker in a client device of an AR system according to an exemplary embodiment of the present invention.

FIG. 8 is a flowchart illustrating a method for updating area information of a marker in a client device of an AR system according to an exemplary embodiment of the present invention.

FIG. 9 is a flowchart illustrating a method for sharing an AR object using a divided marker in a client device of an AR system according to an exemplary embodiment of the present invention.

FIG. 10 is a flowchart illustrating a method for sharing a divided marker and providing an AR service in a host device of an AR system according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth herein. Rather, these exemplary embodiments are provided so that the present disclosure is thorough, and will fully convey the scope of the invention to those skilled in the art. In the drawings, the size and relative sizes of layers and regions may be exaggerated for clarity. Like reference numerals in the drawings denote like elements.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that for the purpose of this disclosure, “at least one of X, Y, and Z” can be construed as X only, Y only, Z only, or any combination of two or more items X, Y, and Z (e.g., XYZ, XY, YZ, XZ).

Exemplary embodiments of the present invention may provide an augmented reality (AR) system and method for dividing a marker into multiple areas and providing an access authorization with respect to each of the multiple areas to share an AR object with a user having an access authorization to each of the multiple areas.

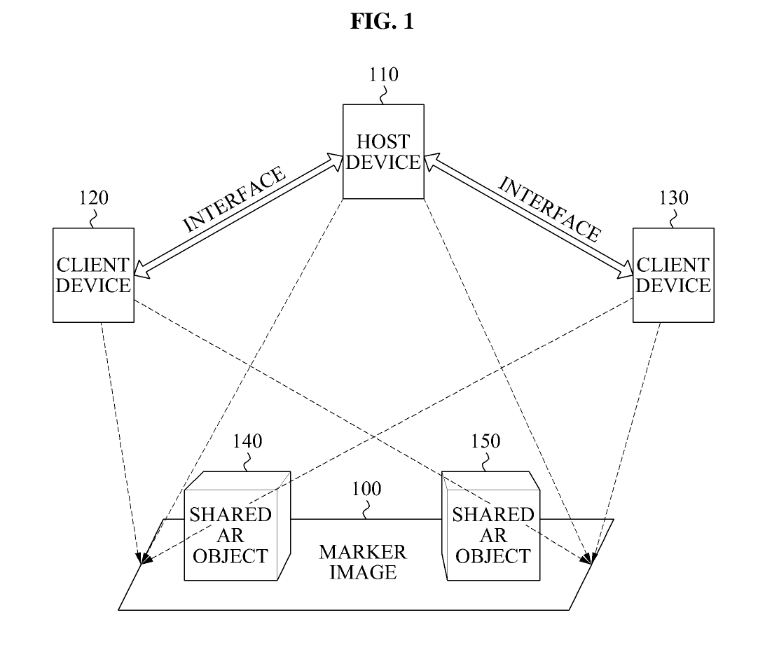

FIG. 1 is a diagram illustrating an augmented reality (AR) system according to an exemplary embodiment of the present invention.

As shown in FIG. 1, the AR system may include a host device 110 and client devices 120 and 130.

The host device 110 may enable the client devices 120 and 130 to share a marker image 100, area information of the marker image 100, and AR objects 140 and 150. The AR object 140 and the AR object 150 may be mapped to a different area of the marker image 100.

The host device 110 may be an independent server. Further, the host device 110 may be configured to be included in one of the client devices 120 and 130, or each of the client devices 120 and 130 may include a portion of or all the operations of the host device 110.

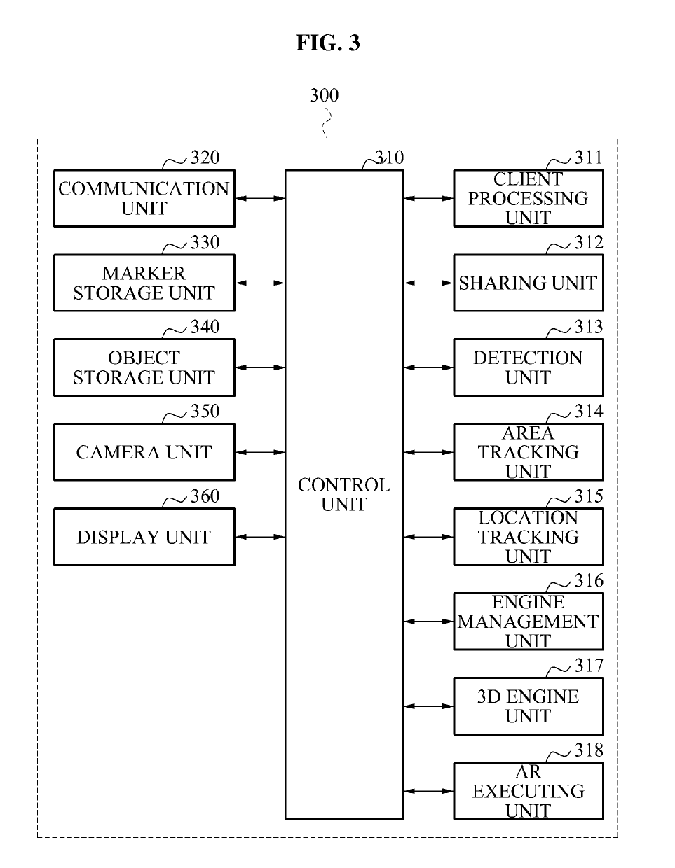

The client devices 120 and 130 may share information of the marker image 100, area information of the marker image 100, and information of the AR objects 140 and 150 via communication with the host device 110 or via communication with each other. The client devices 120 and 130 may display the AR objects 140 and 150 mapped in an area of the marker image 100 if the client devices 120 and 130 have an access authorization to the area of the marker image 100 and the marker image 100 is included in a preview image. The preview image may be a real-world image displayed on the client devices 120 and 130 when the client devices 120 and 130 capture the real world image using an image capturing unit, such as a camera unit 350 shown in FIG. 3.

For example, the marker image 100 may be divided into a first area and a second area. The AR object 140 may be mapped to the first area and the AR object 150 may be mapped to the second area. If the client device 120 has an access authorization to the first area, the client device 120 may share the AR object 140 with the other authorized client devices. If the client device 120 does not have an access authorization to the second area, the client device 120 may not access to or display the AR object 150.

The information of the marker image 100 may include identification information of the marker image 100, marker image size, two-dimensional barcode data information, and the like. The area information of the marker image 100 may include the number of areas included in the marker image 100, layout information of the marker image 100, and the like. The information of the AR object may include corresponding area information, a type of an AR object, states of the AR object, displaying direction of the AR object, and the like.

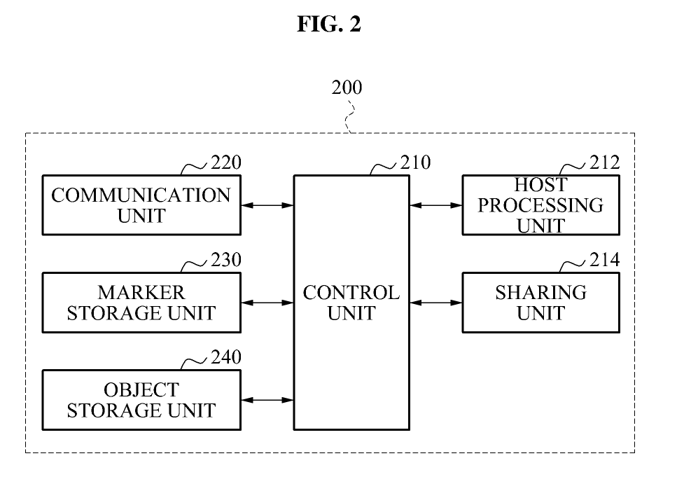

FIG. 2 is a block diagram illustrating a host device in an AR system according to an exemplary embodiment of the present invention.

As shown in FIG. 2, the host device 200 may include a control unit 210, a communication unit 220, a marker storage unit 230, an object storage unit 240, a host processing unit 212, and a sharing unit 214.

The communication unit 220 may transmit and receive data by a wired communication and/or a wireless communication. The communication unit 220 may communicate with the host device 200 or other client devices. The communication unit 220 may include a near field communication network, such as a wireless fidelity (Wi-Fi), a Bluetooth, and an infrared communication.

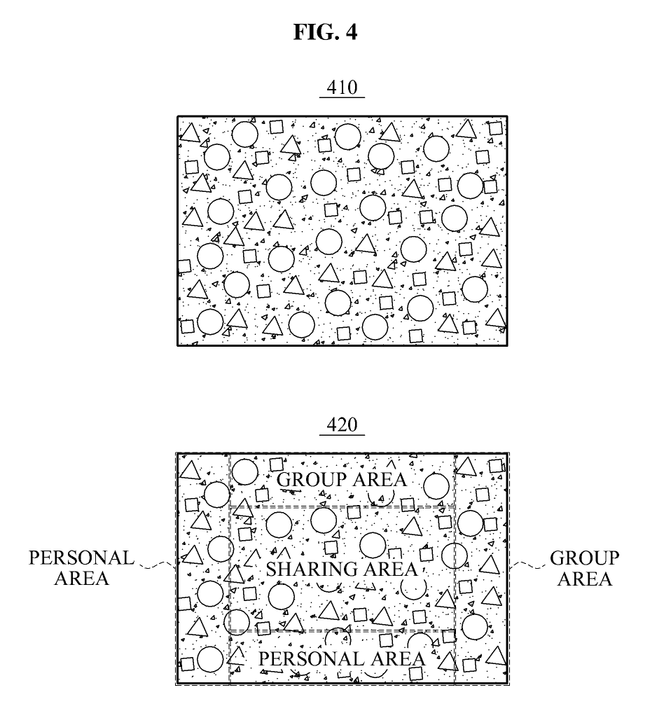

The marker storage unit 230 may store information of a marker and area information of the marker. The information of a marker may include at least one of an image of the marker (marker image), identification information of a marker used for identifying the marker, and tracking information used for location tracking of a marker. The area information of the marker may include information about divided areas (area division information) and version information of the area information of the marker. The version information of the area information of the marker may be used for a consistency among client devices sharing information. A marker may be divided into multiple areas as illustrated in FIG. 4, and types of the divided areas may include a personal area, a group area, a sharing area, and the like.

FIG. 4 is a diagram illustrating a marker divided into multiple areas according to an exemplary embodiment of the present invention.

Referring to FIG. 4, a marker 410 may be divided into a divided area 420 including a personal area, a group area, and a sharing area.

A marker may exist on a two-dimensional flat plane in a real world as a two-dimensional image, but need not be limited as such. The marker may be used to display a three-dimensional graphic model, an AR object, mapped to the marker to a display device. The marker may provide information of the three-dimensional graphic model mapped to the marker, such as size, direction and location information of the three-dimensional graphic model. Various markers and three-dimensional graphic models may be selected by a user.

The object storage unit 240 may store information of AR objects mapped to each area of the marker.

The information of a marker, the area information of the marker, and the AR object may be determined and stored, or may be received from client devices through the communication unit 220.

The sharing unit 214 may share the information of a marker and the area information of the marker with client devices participating in an AR session. If one or more client devices have an access authorization to an area of the marker, the sharing unit 214 may enable an AR object corresponding to the area of the marker to be shared among the one or more client devices having the access authorization for the area. Thus, an access authorization may be required for each area of the marker to be authorized to access an AR object corresponding to each area of the marker.

If the sharing unit 214 receives a change request message, requesting a change of the area information of a marker, from a client device, the sharing unit 214 may identify changed area information included in the change request message, and may transmit the changed area information to the client devices participating in the AR session. Further, the sharing unit 214 may determine whether to change the area information of the marker in response to the change request message. If the sharing unit 214 determines to change the area information of the marker in response to the change request message, the sharing unit 214 may transmit a change request response message as a response to the client device.

If the host processing unit 212 receives a session generation request message, requesting a generation of an AR session, from a client device, the host processing unit 212 may identify the area information of the marker, included in the session generation request message, and may start an AR session using the marker.

If an invitation list is included in the session generation request message, the sharing unit 214 may transmit information about the AR session to client devices included in the invitation list, or may broadcast information about the AR session.

The information about the AR session may include at least one of an image of a marker, area information of the marker, a participant list, information of an AR service to be executed, a start time of the AR session, an end time of the AR session, and a log record of the AR session.

If the host processing unit 212 receives a session participation request message, requesting participation in the AR session, from a client device, the host processing unit 212 may determine whether the participation of the client device is authorized, and may transmit authorization information about whether the participation of the client device is authorized to the client device. The authorization information may be a participation authorization message, or a participation denial message.

The authorization of the participation of the client device may be determined based on a determined condition, a determination of the client device which requests the generation of the AR session or an opinion of one or more client devices currently participating in the AR session.

The control unit 210 may control overall operation of the host device 200. The control unit 210 may perform a portion of or all the operations of the host processing unit 212 and the sharing unit 214. The control unit 210, the host processing unit 212, and the sharing unit 214 are separately illustrated to describe each operate separately. Thus, the control unit 210 may include one or more processors to perform one or more operations of the host processing unit 212 and the sharing unit 214. The control unit 210 may perform a portion of the operations of the host processing unit 212 and the sharing unit 214.

FIG. 3 is a block diagram illustrating a client device in an AR system according to an exemplary embodiment of the present invention.

Referring to FIG. 3, the client device 300 may include a control unit 310, a communication unit 320, a marker storage unit 330, an object storage unit 340, a camera unit 350, a display unit 360, a client processing unit 311, a sharing unit 312, a detection unit 313, an area tracking unit 314, a location tracking unit 315, an engine management unit 316, a three-dimensional (3D) engine unit 317, and an AR executing unit 318.

The communication unit 320 may transmit and receive data by a wired communication and/or a wireless communication. The communication unit 320 may communicate with client devices. The communication unit 320 may include a near field communication network, such as Wi-Fi, a Bluetooth, and an infrared communication.

The marker storage unit 330 may include information of a marker and area information of the marker. The information of a marker may include at least one of an image of the marker, identification information of the marker used for identifying the marker, and tracking information used for location tracking of the marker. The area information of the marker may include information about one or more divided areas and version information of the area information of the marker. The version information of the area information of the marker may be used for a consistency among client devices sharing information. In this instance, the divided areas may be divided into multiple areas as illustrated in FIG. 4, and types of the divided areas may include a personal area, a group area, a sharing area, and the like.

The object storage unit 340 may store information of AR objects mapped to each area of the marker.

The information of a marker, the area information of the marker, and the AR object may be determined and stored, or may be received from a host device or another client device through the communication unit 320.

The camera unit 350 may include a device capturing an image, and may provide the detection unit 313 and the display unit 360 with a captured image or a preview image. In this instance, the captured image and the preview image may be corrected through an image correction or a camera correction before the provision to the detection unit 313 and the display unit 360.

The display unit 360 may display information about a state of an operation of the client device 300, an indicator, figures, characters, a moving picture, a still picture, and the like. The display unit 360 may display an image or a marker received through the camera unit 350, and may display an AR object generated in the 3D engine unit 317.

The sharing unit 312 may share information of a marker, area information of the marker, and information of an AR object with the host device and the other client devices participating in the AR session.

The detection unit 313 may detect a marker in a preview image received from the camera unit 350.

The area tracking unit 314 may track an area of the marker included in the preview image using the area information of the marker.

The location tracking unit 315 may track a location of the client device 300 capturing a preview image including the marker. The location tracking unit 315 may acquire location information of the client device 300 using the tracking information of the marker.

The engine management unit 316 may determine whether to display the AR object on the tracked area included in the preview image based on the location of the client device 300 if the client device has an access authorization to the tracked area, and may display the AR object through the 3D engine unit 317 if the AR object is determined to be displayed on the preview image. The shape of the AR object may be determined based on the location of the client device 300. That is, the viewing direction of the AR object may be determined based on the location of the client device 300.

The 3D engine unit 317 may generate an AR object based on the location of the client device 300 under the control of the engine management unit 316, and may display the AR object on the display unit 360.

The AR executing unit 318 may execute an AR service to control an operation of the AR object, and may enable sharing of information of a changed AR object through the sharing unit 312. The information of a changed AR object may refer to information of an AR object including changed information of the AR object. In an example, a shape of the AR object may be changed during the operation of the AR object. Further, the viewing direction of the AR object may be changed if the location of the client device 300 changes. Various changes of the AR object may be included in the information of the AR object and be shared with the other client devices by transmitting the information of the AR object.

If the client processing unit 311 detects an event of generating an AR session in response to a request of a user of the client device 300, the client processing unit 311 may identify the area information of the marker by retrieving stored information or by receiving an input from the user, and may transmit a session generation request message, requesting a generation of the AR session, including the information of the marker and the area information of the marker, to the host device.

If the client processing unit 311 receives a session participation request message, requesting a participation in the AR session, from another client device, the client processing unit 311 may receive information about a determination whether to authorize the participation of the another client device from a user, and may transmit the information to another client device. In this instance, the client processing unit 311 may transmit the information through the host device. Further, the information about a determination whether to authorize the participation may be a participation authorization message if the user authorizes the participation of another client device. If the user does not authorize the participation of another client device, the information may be a participation denial message.

The client processing unit 311 may acquire information about an AR session from the host device, and may transmit a session participation request message, requesting a participation in the AR session, to the host device. The information about the AR session may be obtained by receiving a one-on-one communication signal or a broadcasting signal.

The client processing unit 311 may acquire the information about an AR session through a reception of a signal transmitted from the host device to the client device 300, and may acquire the information about an AR session through a signal broadcasted by the host device.

The information about an AR session may include at least one of an image of a marker, area information of the marker, a participant list, information of an AR service to be executed, a start time of the AR session, an end time of the AR session, and a log record of the AR session.

Further, the client device 300 may include an authorization processing unit (not shown). The authorization processing unit may request an access authorization for each of areas of the marker to a host device or another client device having an authority to give the access authorization. If the authorization processing unit receives an access authorization for an area of the marker, the client device 300 may receive information of an AR object mapped to the area of the marker, and may extract the AR object mapped to the area of the marker.

The control unit 310 may control overall operation of the client device 300. The control unit may perform a portion of or all the operations of the client processing unit 311, the sharing unit 312, the detection unit 313, the area tracking unit 314, the location tracking unit 315, the engine management unit 316, the 3D engine unit 317, the AR executing unit 318, and the authorization processing unit. The control unit 310, the client processing unit 311, the sharing unit 312, the detection unit 313, the area tracking unit 314, the location tracking unit 315, the engine management unit 316, the 3D engine unit 317, and the AR executing unit 318 are separately illustrated to describe each operate separately. Thus, the control unit 310 may include one or more processors to perform one or more operations of the client processing unit 311, the sharing unit 312, the detection unit 313, the area tracking unit 314, the location tracking unit 315, the engine management unit 316, the 3D engine unit 317, and the AR executing unit 318. The control unit 310 may perform a portion of the operations of the client processing unit 311, the sharing unit 312, the detection unit 313, the area tracking unit 314, the location tracking unit 315, the engine management unit 316, the 3D engine unit 317, and the AR executing unit 318.

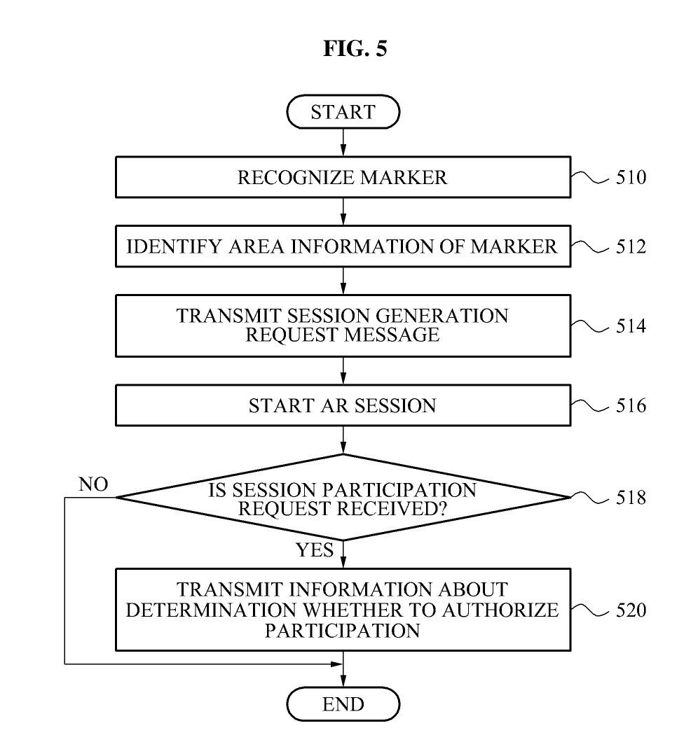

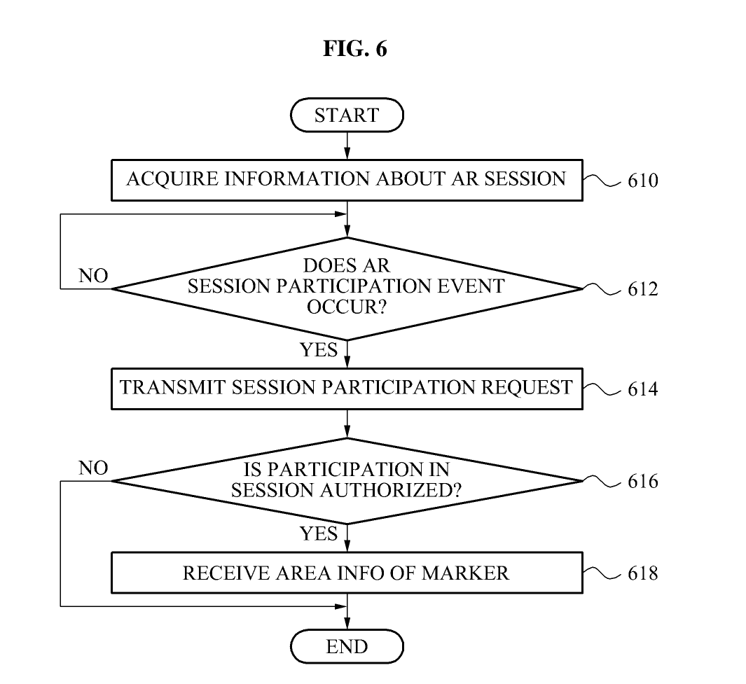

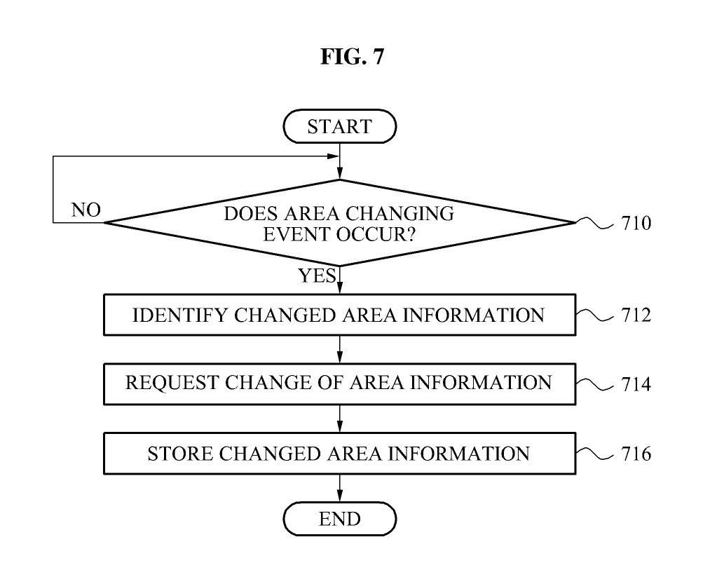

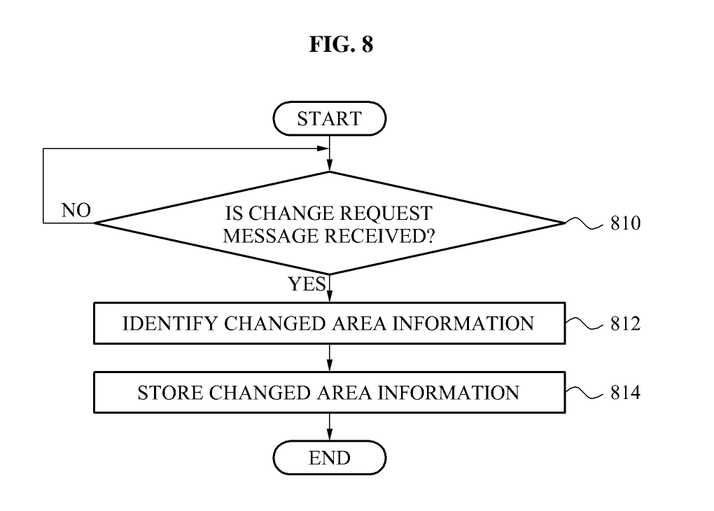

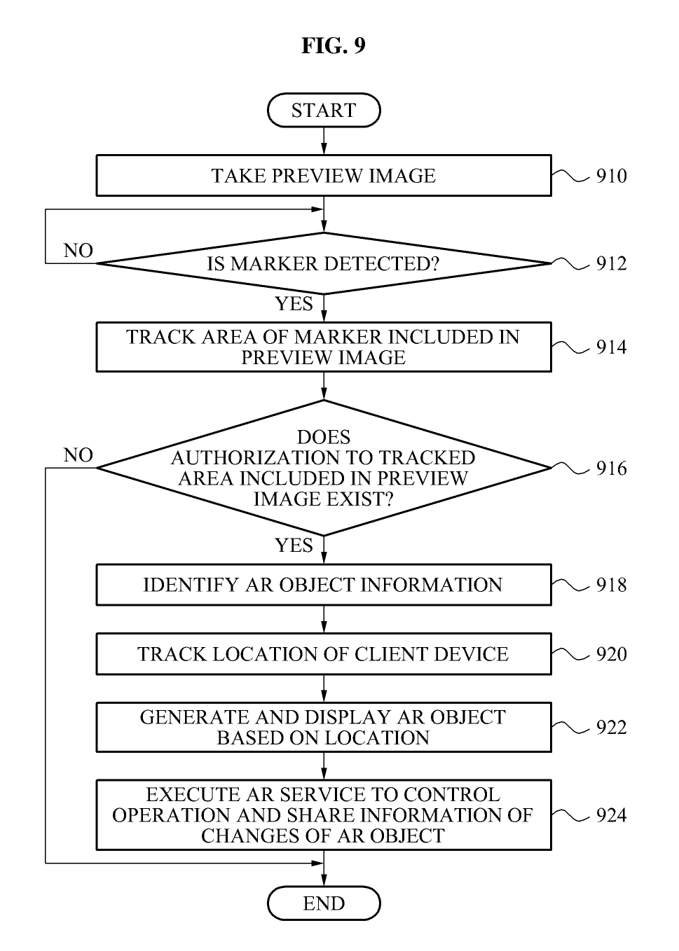

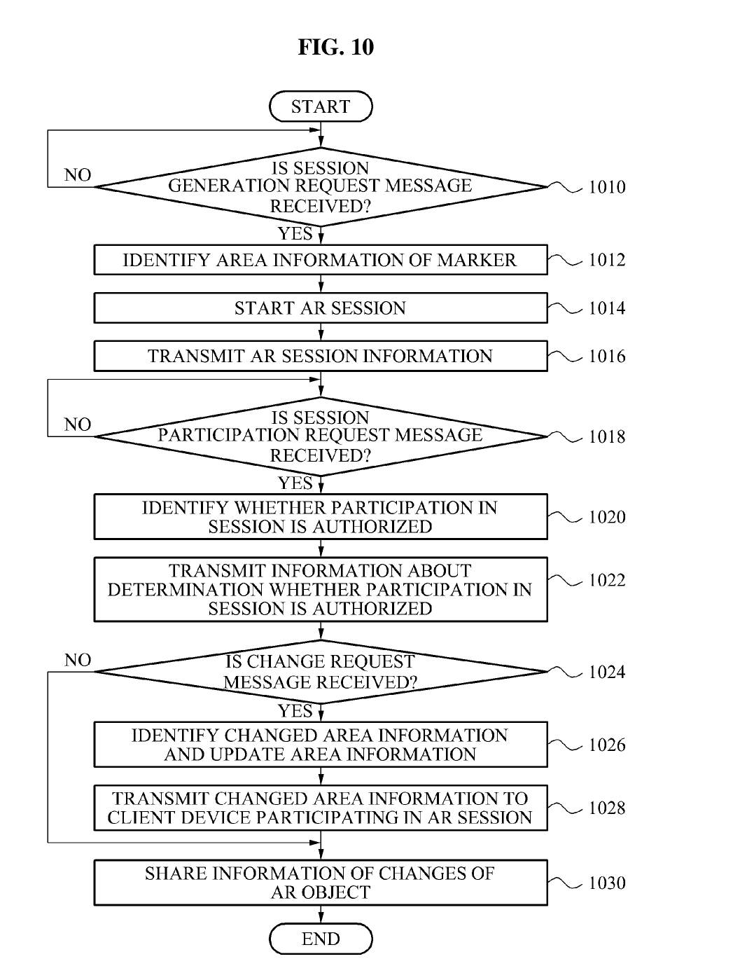

Hereinafter, a method for providing an AR service by dividing and sharing a marker will be described with reference to FIG. 5, FIG. 6, FIG. 7, FIG. 8, FIG. 9, and FIG. 10. These methods may be described as performed by or with the AR system shown in FIG. 1, FIG. 2, and FIG. 3, but these methods are not limited thereto.

FIG. 5 is a flowchart illustrating a method for generating an AR session in a client device of an AR system according to an exemplary embodiment of the present invention.

Referring to FIG. 5, in operation 510, the client device may recognize a marker.

In operation 512, the client device may identify area information of the marker by retrieving stored information or by receiving an input.

In operation 514, the client device may request a generation of the AR session by transmitting a session generation request message, requesting a generation of the AR session, including the information of the marker and the area information of the marker to a host device.

In operation 516, the client device may start the AR session.

If the client device receives a session participation request message, requesting a participation in the AR session, from another client device through the host device in operation 518, the client device may receive information about a determination whether to authorize the participation of the another client device from a user, and may transmit the information to the another client device in operation 520.

FIG. 6 is a flowchart illustrating a method for participating in an AR session in a client device of an AR system according to an exemplary embodiment of the present invention.

Referring to FIG. 6, in operation 610, the client device may acquire information about an AR session. The client device may acquire the information about an AR session through a reception of a signal transmitted from a host device to the client device, or may acquire the information about an AR session through a signal broadcasted by the host device.

If the client device detects an event, requesting a participation in the AR session, by receiving a participation request input from a user in operation 612, the client device may transmit a session participation request message, requesting a participation in the AR session, to the host device in operation 614.

If the client device is authorized to participate in the AR session in operation 616, the client device may receive area information of the marker from the host device in operation 618.

FIG. 7 is a flowchart illustrating a method for changing area information of a marker in a client device of an AR system according to an exemplary embodiment of the present invention.

Referring to FIG. 7, if the client device detects an area changing event, requesting a change of an area of a marker, by receiving an area change request from a user in operation 710, the client device may receive changed area information from the user and identify the changed area information in operation 712.

In operation 714, the client device may transmit a change request message including the changed area information to the host device, and thereby requesting a change of the area information of the marker.

In operation 716, the client device may store the changed area information.

FIG. 8 is a flowchart illustrating a method for updating area information of a marker in a client device of an AR system according to an exemplary embodiment of the present invention.

Referring to FIG. 8, if the client device receives a change request message, requesting a change of area information of a marker, from a host device in operation 810, the client device may identify changed area information included in the change request message in operation 812.

In operation 814, the client device may update the area information of the marker with the changed area information, and store the changed area information.

FIG. 9 is a flowchart illustrating a method for sharing an AR object using a divided marker in a client device of an AR system according to an exemplary embodiment of the present invention.

Referring to FIG. 9, in operation 910, the client device may take or capture a preview image.

If a marker is detected in the preview image taken by the client device in operation 912, the client device may track an area of the marker included in the preview image using area information of the marker in operation 914.

In operation 916, the client device may identify whether the client device has an access authorization to the tracked area of the marker included in the preview image.

If the client device has an access authorization to the tracked area, the client device may identify an AR object mapped to the track area in operation 918. In an example, information of the AR object may be transmitted from a host device if the client device has the access authorization.

In operation 920, the client device may track a location of the client device using tracking information of the marker. Location information of the client device may be acquired and stored after tracking the location of the client device.

In operation 922, the client device may generate an AR object according to the location information of the client device, and display the AR object.

In operation 924, the client device may execute an AR service to control an operation of the AR object, and share information of one or more changes of the AR object with the other client devices.

FIG. 10 is a flowchart illustrating a method for sharing a divided marker and providing an AR service in a host device of an AR system according to an exemplary embodiment of the present invention.

Referring to FIG. 10, if the host device receives a session generation request message, requesting a generation of an AR session, in operation 1010, the host device may identify area information of a marker included in the session generation request message in operation 1012.

In operation 1014, the host device may start an AR session, sharing a marker divided into multiple areas based on area information of the marker.

In operation 1016, if an invitation list is included in the session generation request message, the host device may transmit information about the AR session to client devices included in the invitation list, or may broadcast information about the AR session.

The information about an AR session may include at least one of an image of the marker, area information of the marker, a participant list, information of an AR service to be executed, a start time of the AR session, an end time of the AR session, and a log record of the AR session.

If the host device receives a session participation request message, requesting a participation in the AR session, from the client device in operation 1018, the host device may identify whether the client device is authorized to participate in the AR session in operation 1020.

The participation authorization of the client device may be determined based on a determined condition, a determination of the client device that transmits the session generation request message for requesting the generation of the AR session or a determination of one or more client devices currently participating in the AR session.

In operation 1022, the host device may transmit information about a determination whether the participation in the AR session for the client device is authorized to the client device which transmits the session participation request message. In an example, the information about the determination may be a participation authorization message or a participation denial message.

If the host device receives a change request message, requesting a change of area information of the marker, from the client device, in operation 1024, the host device may identify changed area information included in the change request message and update the area information of the marker in operation 1026.

In operation 1028, the host device may transmit the changed area information to client devices participating in the AR session.

In operation 1030, the host device may execute an AR service to control an operation of the AR object, and may share information of one or more changes of the AR object with client devices participating in the AR session.

Aspects of the present invention may be implemented as an application program. An example of the application program will be described below.

Aspects of the present invention may be applied to a conference system.

The conference system may determine a meeting table as a marker, and may divide the marker into multiple areas including one or more personal areas, a group area, and a sharing area. The conference system may allocate the closest personal area to a user if the user sits on a chair, and allocate the group area to certain participants having the same opinion.

Shared data or related materials may be displayed in the sharing area during a conference. Private data of a participant may be restricted to authorized participants, and an access authorization may be changed by the owner of the private data. The access authorization may be classified into several types, for example, a copy authorization to authorize a participant to copy the data, an access authorization to authorize a participant to access or view the data, an editing authorization to authorize a participant to edit the data, and the like.

Meeting minutes or conferment results may be moved to the sharing area, and may be edited by multiple users.

Aspects of the present invention may be applied to an auction system.

The auction system may determine a meeting table as a marker, and may divide the marker into multiple areas including a personal area and a sharing area, and may allocate the closest personal area to an auction participant if the auction participant sits on a chair.

The auction system may display an auction item, as an AR object, and information about the auction item, in the sharing area.

The auction participant may determine a bidding price for the auction item, and may display the bidding price as an AR object in the personal area.

If a competitive bid is completed, the auction system may change all areas to a sharing area, and determine a successful bidder of the auction.

Aspects of the present invention may be applied to a racing game, a strategy simulation game, and the like by sharing a marker divided into multiple areas with the other participants using an authorization operation.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the aspects of the present invention, or they may be of the kind well-known and available to those having skill in the computer software arts. Examples of non-transitory computer-readable media include magnetic media, such as hard disks, floppy disks, and magnetic tape; optical media, such as CD ROM discs and DVD; magneto-optical media, such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Exemplary embodiments of the present invention provide a system and method for providing an AR service and sharing a marker having multiple areas. The marker is divided into multiple areas, and each of the multiple areas may require an access authorization to obtain an AR object corresponding to each of the multiple areas. An AR object corresponding to an area among the multiple areas of the marker may be shared with multiple users who have an access authorization to the area. Thus, a marker may be used for various AR services and may display multiple AR objects, thereby reducing the number of markers required for an AR service. Further, an access to an area of the marker may be limited to authorized users in various applications.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalent.

What is claimed is:

1. A first client device of an augmented reality (AR) system, the first client device comprising:
a detection unit to identify a marker comprising a first area and a second area;
a sharing unit to transceive information of the marker and area information of the marker;
an area tracking unit to identify the first area and the second area using the area information of the marker;
an engine management unit to extract a first AR object corresponding to the first area and a second AR object corresponding to the second area; and
an engine unit to display the first AR object and the second AR object.

2. The first client device of claim 1, wherein the first area is a sharing area or a group area, and
the sharing unit shares information of the first AR object with a second client device if the second client device has an access authorization to the first area.

3. The first client device of claim 1, further comprising:
a location tracking unit to identify a location of the first client device,
wherein the engine management unit determines viewing direction of the first AR object based on the location of the first client device, and extracts the first AR object based on the viewing direction of the first AR object, and displays the first AR object through the engine unit.

4. The first client device of claim 1, further comprising:
an AR executing unit to control the first AR object, and to generate information of the first AR object,
wherein the sharing unit transmit the information of the first AR object to a second client device.

5. The first client device of claim 1, further comprising:
a client processing unit to identify the area information of the marker, and to transmit a session generation request message to request a generation of an AR session comprising the information of the marker and the area information of the marker.

6. The first client device of claim 5, wherein the client processing unit receives a session participation request message for requesting participation in the AR session from a second client device, and transmits a participation authorization message.

7. The first client device of claim 1, further comprising:
a client processing unit to obtain information about an AR session from a host device or a second client device, and to transmit a session participation request message to request a participation in the AR session to the host device or the second client device.

8. The first client device of claim 7, wherein the information about an AR session comprises at least one of information of the marker, area information of the marker, a participant list, information of an AR service, a start time of the AR session, an end time of the AR session, and a log record of the AR session.

9. The first client device of claim 7, wherein the client processing unit obtains the information about an AR session by receiving a one-on-one communication signal or a broadcasting signal.

10. The first client device of claim 1, wherein the sharing unit transmits a change request message comprising changed area information to request a change of the area information of the marker, and receives a change request response message.

11. The first client device of claim 1, wherein the sharing unit receives a change request message, requesting a change of the area information of the marker, transmits a change request response message in response to the change request message, identifies changed area information comprised in the change request message, and updates the area information of the marker.

12. The first client device of claim 1, further comprising:
an authorization processing unit to receive a first access authorization for the first area or a second access authorization for the second area,
wherein the engine management unit extracts the first AR object if the authorization processing unit has the first access authorization, or the engine management unit extracts the second AR object if the authorization processing unit has the second access authorization.

13. A host device of an augmented reality (AR) system, the host device comprising:
an object storage unit to store a first AR object corresponding to a first area of a marker and a second AR object corresponding to a second area of the marker; and
a sharing unit to transmit information of the marker and area information of the marker to one or more client devices participating in an AR session, to transmit information of the first AR object corresponding to the first area of the marker to one or more client devices if the one or more client devices have an access authorization to the first area of the marker, and to transmit information of the second AR object corresponding to the second area of the marker to one or more client devices if the one or more client devices have an access authorization to the second area of the marker.

14. The host device of claim 13, further comprising:
a marker storage unit to store the information of the marker and the area information of the marker;
a host processing unit to identify the area information of the marker comprised in a session generation request message for requesting a generation of an AR session, and to start the AR session in response to the session generation request message,
wherein the sharing unit transmits information about the AR session to one or more client devices comprised in an invitation list if the invitation list is comprised in the session generation request message, or the sharing unit broadcasts the information about the AR session.

15. The host device of claim 14, wherein the host processing unit receives a session participation request message for requesting a participation in the AR session from a client device, identifies whether the client device is authorized to participate in the AR session, and transmits a participation authorization message to the client device.

16. The host device of claim 14, wherein the information about the AR session comprises at least one of information of the marker, area information of the marker, a participant list, information of an AR service, a start time of the AR session, an end time of the AR session, and a log record of the AR session.

17. The host device of claim 13, wherein the sharing unit receives a change request message requesting a change of area information of the marker, identifies changed area information comprised in the change request message, and transmits the changed area information to the one or more client devices participating in the AR session.

18. A method for providing an augmented reality (AR), the method comprising:
detecting a marker comprising a first area and a second area in a preview image;
sharing information of the marker and area information of the marker;
identifying the first area and the second area of the marker using the area information of the marker;
identifying a first AR object corresponding to the first area or a second AR object corresponding to the second area; and
displaying the first AR object or the second AR object.

19. The method of claim 18, further comprising:
receiving an access authorization for the first area or receiving an access authorization for the second area; and
receiving information of the first AR object if the access authorization for the first area is received or receiving information of the second AR object if the access authorization for the second area is received,
wherein the marker further comprises a third area, the third area is a sharing area or a group area, and a third AR object corresponding to the third area is shared among one or more clients without an authorization process.

20. The method of claim 18, further comprising:
recognizing the first area of the marker and the second area of the marker;
identifying the information of the marker and the area information of the marker; and
transmitting a session generation request message to request a generation of an AR session comprising the information of the marker and the area information of the marker.

21. A method for providing an augmented reality (AR), the method comprising:
establishing an AR session using a marker having a first area and a second area;
determining one or more client devices as participants of the AR session;
sharing information of the marker and area information of the marker with the one or more client devices participating in the AR session; and
sharing at least one of a first AR object corresponding to the first area of the marker and a second AR object corresponding to the second area of the marker with a client device according to an authorization.

22. The method of claim 21, further comprising:
receiving a session generation request message comprising a participants list; and
extracting the one or more client devices from the participants list,
wherein establishing of the AR session is performed in response to the session generation request message.
